(19) United States
(12) Patent Application Publication
(10) Pub. No.: US 2009/0164081 A1
(43) Pub. Date: Jun. 25, 2009

(54) METHOD FOR OPTIMIZING CRUISE CONTROL FUEL ECONOMY IN HEAVY DUTY DIESEL ENGINES

(75) Inventors: Victor J. Meloche, Canton, MI (US); Joseph J. Michalek, Redford, MI (US); Charles C. Blake, Commerce, MI (US); Dennis M. Letang, Canton, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Detroit Diesel Corporation, Detroit, MI (US)

(21) Appl. No.: 11/961,386

(22) Filed: Dec. 20, 2007

(51) Int. Cl. B60W 30/14; G06F 17/11

(52) U.S. Cl. 701/94; 701/93

(57) ABSTRACT

A method to operate a vehicle with an electronically controlled internal combustion engine equipped with an electronic control unit with memory and capable of operating the engine in a cruise control mode.

### BACKGROUND OF THE INVENTION

1. Field of the Invention

The present invention relates to a method to operate a vehicle with an electronic controlled internal combustion engine while in cruise control mode to allow the vehicle speed to decrease a calibratable pre-determined amount while climbing a gradient without changing the cruise control set speed.

The present invention further relates to a method to operate a vehicle with an electronic central heavy duty diesel engine while in cruise control to reduce the available engine torque available at pre-determined vehicle speeds to a vehicle speed minimum threshold, at which point the maximum available engine torque is available at such minimum threshold speed.

The present invention further relates to a soft cruise control feature for use with electronic controlled heavy duty diesel engines during cruise control operation that mimics actual drive operation of the vehicle while climbing a gradient or descending a gradient preparatory to climbing the next gradient.

2. Description of the Related Art

Bellinger, U.S. Pat. No. 6,546,329 discloses a system for controlling a vehicle drive train in a fuel efficient manner that includes in one embodiment a control computer operable to determine a number of engine load/engine speed boundary conditions as functions of brake specific fuel consumption (BSFC) contours in relation to an energy output characteristics map and define therefrom an undesirable engine operation region U. As long as the engine is engaged with at least one of the gear ratios of the vehicle transmission, the control computer is operable to maintain or encourage engine operation outside of the region U. In another embodiment the control computer is operable to define a contour from substantially zero engine load to substantially full engine load wherein the contour preferably corresponds to a fuel efficient path from no load to full load engine operating conditions. With change gear transmissions, the control computers operable to control transmission shift points about the contour. With continuous variable transmissions, the control computer is operable to modify the affective gear ratio thereof to maintain engine operation on or above the contour. In either case, fuel efficient operation may be optimized.

### BRIEF SUMMARY OF THE INVENTION

The present invention relates to an indirect method of controlling wheel speed while in cruise control that adjusts a speed limit (i.e., reduces the set speed) based on actual engine torque. The method monitors engine torque. If the torque exceeds a torque threshold corresponding to an expected maximum power needed to maintain a cruise set on a level road, the method of the present invention applies a reduction to the cruise control set speed. To ensure smooth operation, the engine torque used to calculate the set speed reduction is filtered. In addition, the speed reduction is limited to a maximum rate of change. The method further provides for a delay in the introduction of this feature, especially if a vehicle so equipped is already climbing a gradient, as otherwise it could seem to the driver that the cruise control has not been properly activated, with the vehicle speed dropping below a desired set point immediately. The feature of the present invention is generally active when cruise control is active. However, the method of the present invention is generally not active in cruise mode if the set speed is lower than the minimum cruise set speed or the feature is delayed as set forth above.

More particularly, the present invention is directed to a method to operate a vehicle with an electronic control internal combustion engine equipped with an electronic control unit with memory and capable of operating the engine in a cruise control mode. The method comprises applying a cruise control set speed, monitoring actual vehicle speed and requested cruise control engine torque to operate vehicle within predetermined limits, and applying a calibratable reduction to said cruise control engine torque proportional to a loss of vehicle speed when said cruise control engine torque exceeds a calibratable horsepower threshold corresponding to a calculated maximum horsepower required to maintain said cruise control set speed on a substantially level surface.

The method further includes implementing a beyond predetermined calibratable vehicle speed reduction, at which maximum engine torque is made available at that vehicle speed. Further the calibratable engine brake on speed thresholds to permit said vehicle to given speed and retain inertia when said vehicle is descending a grade to partially prepare to ascend a next grade. If the calibratable engine retarder on/off speeds, the method further includes determining a simple moving average of vehicle acceleration over a calibratable set of data points to determine average acceleration according to formula:

$$AverageAcceleration = \frac{{Accel}_{m} + {Accel}_{m - 1} + … {Accel}_{M - ( N - 1 )}}{N}$$

Wherein
m is a number
N represents the number of data points

The method further includes determining whether said vehicle is descending a grade and how steep is such a grade by measuring whether vehicle speed is greater than cruise set speed, net load is zero and whether average acceleration is positive and greater than or equal to a calibrated threshold. Whether a grade is steep is determined by comparing a simple moving average of vehicle acceleration to a predetermined programmable vehicle acceleration threshold. In addition, determining whether a grade is steep includes determining whether the actual horsepower output is less than a calibratable maximum horsepower before applying calibratable reduction to the cruise control engine torque. The method may further include a low pass filter on engine brake torque to determine engine torque reduction. It is contemplated that the control of vehicle speed and engine torque is non linear. A timer to delay activation of cruise control while vehicle is operating at or above a predetermined load or to delay activation when cruise control has been paused and then re-enabled. The engine retarder may be programmed to on/off thresholds on a per hill basis.

While road grade may be determined as set forth above, it is also contemplated to use Global Position Satellite (GPS) map data to determine road grade

### BRIEF DESCRIPTION OF THE DRAWINGS

FIG. 1 is a schematic representation of a vehicle with an engine, transmission, and electronic control unit;

FIG. 2 is a detailed view of an electronic control unit showing the motor control unit and the computer powertrain controller;

FIG. 3 is a graph showing the function logic of the present invention; and

FIG. 4 is a graph showing the non linear torque response profile between parts A and B of FIG. 3.

FIG. 5 is a representation of a software flow chart of one version of the present invention.

### DETAILED DESCRIPTION OF THE PREFERRED EMBODIMENT

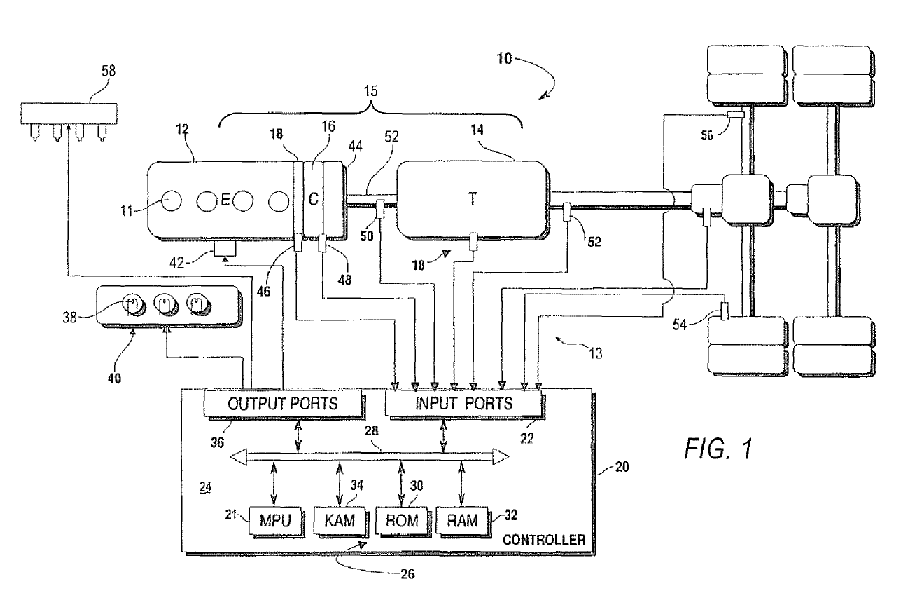

Referring now to FIG. 1, a block diagram illustrating a system including a system for controlling a vehicle powertrain based upon actual vehicle load according to the present invention is shown. The system is particularly suited for use in a vehicle, indicated generally by reference numeral 10, which typically includes an engine 12 coupled to a transmission 14 via a master friction clutch 16. In one embodiment, engine 12 is a compression-ignition internal combustion engine, such as a four, six, eight, or more cylinder diesel engine. Transmission 14 is typically a multiple gear ratio transmission which is manually or semi-automatically actuated to select one of the available gear ratios. Master friction clutch 16 may be manually or automatically controlled by a clutch actuator (not specifically illustrated), or centrifugal force, as is well known in the art. The engine, transmission, and clutch are the vehicle powertrain 15. The vehicle powertrain is shown in accordance with one non-limiting aspect of the present invention. The vehicle powertrain may provide power for driving any number of vehicles, including on-highway trucks, construction equipment, marine vessels, stationary generators, automobiles, trucks, tractor-trailers, boats, recreational vehicle, light and heavy-duty work vehicles, and the like.

Vehicle 10 may also include various sensors 18 for generating signals indicative of corresponding operational conditions or parameters of engine 12, transmission 14, clutch 16, and the like. Sensors 18 are in electrical communication with a controller 20 via input ports 22. Controller 20 preferably includes a microprocessor 24 in communication with various computer readable storage media 26 via data and control bus 28. Computer readable storage media 26 may include any of a number of known devices which function as a read-only memory (ROM) 30, random access memory (RAM) 32, keep-alive memory (KAM) 34, and the like. The computer readable storage media may be implemented by any of a number of known physical devices capable of storing data representing instructions executable via a computer such as controller 20. Known devices may include but are not limited to PROMs, EPROMs, EEPROMs, flash memory, and the like in addition to magnetic, optical and combination media capable of temporary or permanent data storage.

Computer readable storage media 26 include data representing various program instructions, software, and control logic to effect control of various systems and sub-systems of vehicle 10, such as engine 12, transmission 14, and the like. Controller 20 receives signals from sensors 18 via input ports 22 and generates output signals which may be provided to various actuators and/or components via output ports 36. Signals may also be provided to a display device 40 which includes various indicators such as lights 38 to communicate information relative to system operation to the operator of the vehicle.

Sensors 18 preferably include an engine speed sensor 42. Engine speed may be detected using any of a number of known sensors which provide signals indicative of rotational speed for flywheel 44, or various internal engine components such as the crankshaft, camshaft, or the like. In a preferred embodiment, engine speed is determined using a timing reference signal generated by a multi-tooth wheel coupled to the camshaft. A clutch sensor 46 may be provided to determine the clutch slip or engagement position of master friction clutch 16. An input shaft speed sensor 48 may be provided to determine the input speed of transmission 14. An output shaft sensor 50 may be provided to detect the rotational speed of output shaft 52. Wheel speed sensors, such as sensor 54, may be used to provide an indication of the current wheel speed of one or more vehicle wheels. Such sensors are commonly used in traction control systems (TCS) and anti-lock braking systems (ABS). Of course, one or more sensors may provide signals to various other controllers which are eventually communicated to controller 20 rather than being directly connected via input ports 22 as illustrated in FIG. 1.

The controller 20 may include a microprocessor unit (MPU) 21 in communication with various computer readable storage media via a data and control bus 28. The computer readable storage media may include any of a number of known devices which function as read only memory 30, random access memory 32, and non-volatile random access memory 34. A data, diagnostics, and programming input and output device 56 may also be selectively connected to the controller via a plug to exchange various information therebetween. The device 56 may be used to change values within the computer readable storage media, such as configuration settings, calibration variables, instructions for EGR, intake, and exhaust systems control and others.

The system 13 may include an injection mechanism 58 for controlling fuel and/or air injection for the cylinders 11. The injection mechanism 58 may be controlled by the controller 20 or other controller and comprise any number of features, including features for injecting fuel and/or air into a common-rail cylinder intake and a unit that injects fuel and/or air into each cylinder individually. For example, the injection mechanism 58 may separately and independently control the fuel and/or air injected into each cylinder such that each cylinder may he separately and independently controlled to receive varying amounts of fuel and/or air or no fuel and/or air at all. Of course, the present invention contemplates that the injection mechanism 58 may include more or less of these features and is not intended to be limited to the features described above.

In operation, the controller receives signals from various engine/vehicle sensors and executes control logic embedded in hardware and/or software to control the system. The computer readable storage media may, for example, include instructions stored thereon that are executable by the controller to perform methods of controlling all features and sub-systems in the system 10. The program instructions may be executed by the controller in the MPU 21 to control the various systems and subsystems of the engine and/or vehicle through the input/output ports. In general, the dashed lines shown in FIG. 1 illustrate the optional sensing and control communication between the controller and the various components in the powertrain system. Furthermore, it is appreciated that any number of sensors and features may be associated with each feature in the system for monitoring and controlling the operation thereof.

In one non-limiting aspect of the present invention, the controller may be the DDEC controller available from Detroit Diesel Corporation, Detroit, Mich. Various other features of this controller are described in detail in a number of U.S. patents assigned to Detroit Diesel Corporation. Further, the controller may include any of a number of programming and processing techniques or strategies to control any feature in the system. Moreover, the present invention contemplates that the system may include more than one controller, such as separate controllers for controlling system or sub-systems, including an exhaust system controller to control exhaust gas temperatures, mass flow rates, and other features associated therewith. In addition, these controllers may include other controllers besides the DDEC controller described above.

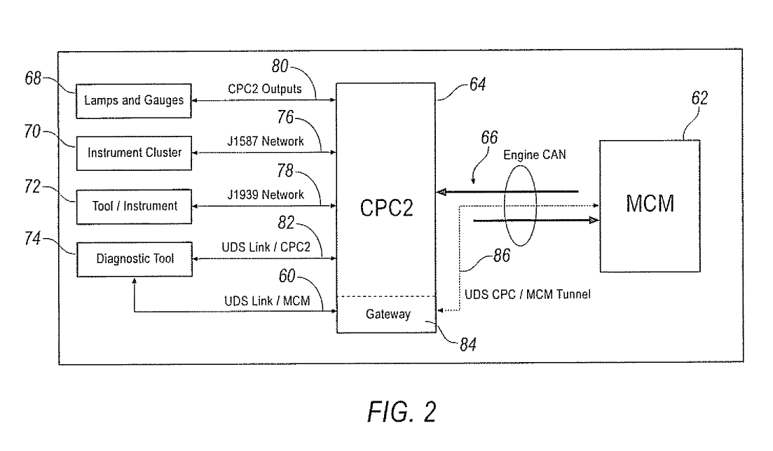

FIG. 2 is a schematic representation of the controller 20 of the present invention. The controller has a Motor Control Module 62 and a Common Powertrain Controller 64. Each of the Common Powertrain Controller and the Motor Control Module has memory for storage and retrieval of operating software and faults. The Motor Control Module and the Common Powertrain Controller communicate with each other via the electronic controller area network (ECAN) 66. It is contemplated that any electronic communication between the Motor Control Module (MCM) and the Common Powertrain Controller is acceptable to communicate static faults stored in either, so that each has the most current version of the faults in the other module at any time. The Common Powertrain Controller communicates with the vehicle systems such as lamps and gauges 68, instrument cluster 70, tool/instrument 72 and diagnostic tool 74. The CPC2 communicates with the instrument cluster and the tool/instrument via an SAE data link J1939 and J 1587, (76 and 78, respectively). CPC2 outputs 80 are communicated to the lamps and gauges, and the CPC2 communicates with the diagnostic tool 74 over a UDS/CPC2 link 82. The CPC2 further acts as a gateway for the MCM to communicate with the diagnostic tool over a UDS link/MCM 86 through the MCM gateway 84 in the CPC2. The MCM communicates to the gateway via a UDS CPC/MCM tunnel 88 and communication is possible with the diagnostic tool.

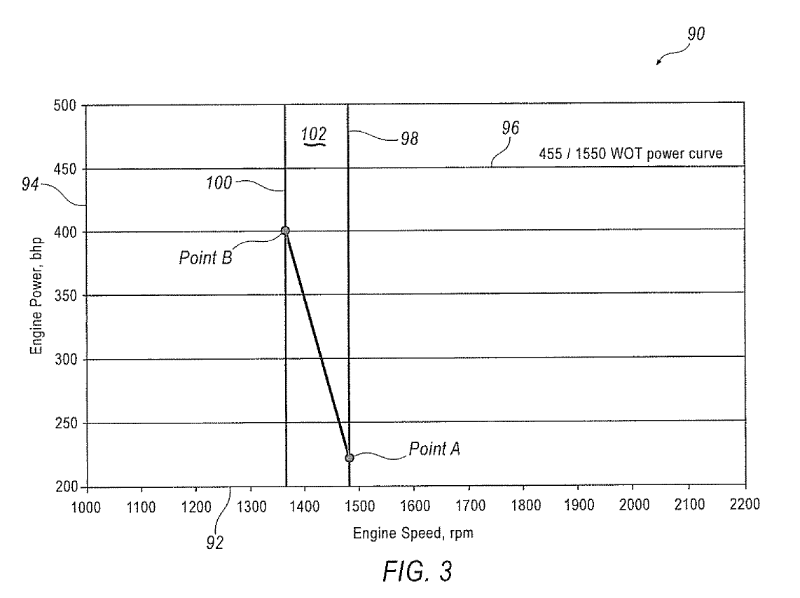

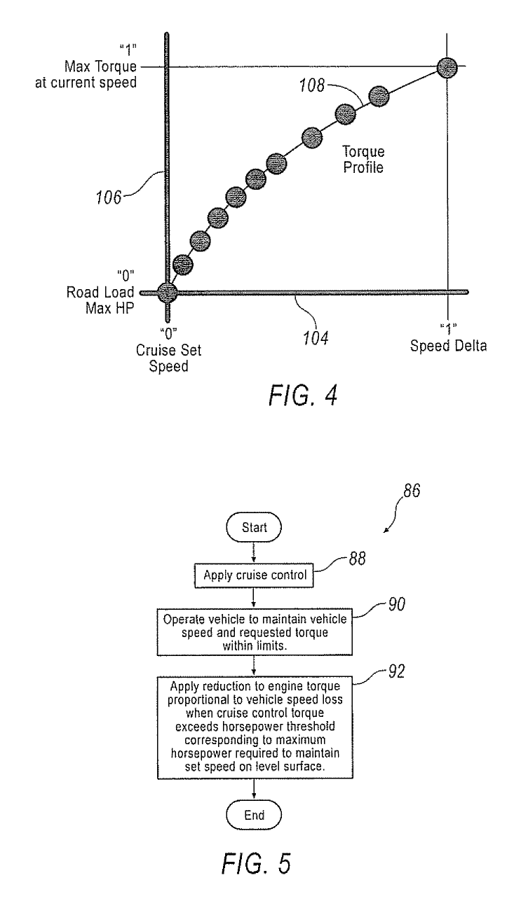

FIG. 3 is a graphic representation of the soft cruise function logic of one method of the present invention. Graph 90 has x axis 92, representing engine speed (rpm), and y axis 94, representing engine power, as measured in braking horse power (bhp). In the example represented in FIG. 3, point A is the engine speed at set vehicle cruise speed and road load power, and point B is the engine speed at set cruise speed minus a speed factor, in this case about 5 mph, at a full engine load. Power curve 96 is representative of an operating engine. Line 98 represents the set cruise speed, of which point A is a part. Line 100 is the set cruise speed minus some set speed, say approximately 5 mph. Area 102 is the vehicle speed range allowable between the set cruise speed and the set cruise speed minus some set speed, representative of the soft cruise feature of the present invention. The relationship between point A and the reduction of speed to point B is linear, and point B is on the torque curve 96. In addition, as seen in FIG. 4 discussed below, the relationship can be non linear. When the vehicle speed is reduced from the set cruise speed represented by point A to the speed at point B, the engine power curve is increased until the set cruise speed at point B is reached, at which point the cruise control system activates fuel rated power/.

Soft cruise functionality as defined in the present invention is enabled if the calibration for the change in soft cruise speed is set to a non-zero value. The soft cruise feature is generally active when cruise control is active if the vehicle set speed is lower than the minimum cruise set speed plus the change in soft cruise speed.

The activation of the soft cruise feature of the present invention may also be delayed. As previously discussed, the soft cruise feature monitors the engine torque. If the engine torque exceeds a predetermined calibratable torque threshold, corresponding to the expected maximum power needed to maintain the cruise set speed on level road, the software applies a reduction to the cruise control set speed. The set speed itself is not changed. Greater reductions are applied for higher torques, up to the calibrated speed itself is not changed. Great reductions may be applied for higher torques, up to the calibrated limit of vehicle speed reduction, which is applied when the engine torque is at the maximum available governor torque at that engine speed. To ensure smooth operation, the engine torque used to calculate the speed reduction is filtered. In addition, the speed reduction is limited to a maximum rate of change.

Upon entering cruise control, it may be desirable to delay the introduction of the soft cruise feature. This is especially true if the vehicle is already climbing a gradient, as otherwise it could seem to the driver that cruise control has not properly activated, the vehicle speed dropping below the desired set point immediately. There are three mechanisms implemented to achieve such a delay:
a. A simple timed delay between cruise control activation and soft cruise logic activation.
b. An option to postpone any soft cruise set speed reduction until level road is next encountered (i.e. torque falls below the threshold), after which soft cruise operates as usual.
c. An option to apply soft cruise set speed reductions only for engine torques greater than the minimum torque seen since cruise control was activated. (Once the torque has fallen below the calibrated threshold, soft cruise operates as usual).
   These measures apply not only when cruise control is activated, but also when the set speed is changed via a coast or an accelerate operation.

The soft cruise may be implemented by limiting the cruise control governor engine torque based on the delta between actual vehicle speed and set speed

Therefore, an indirect method of controlling the torque was developed. It is similar to the approach taken in implementing “droop” for the PTO governor. Instead of adjusting a torque limit based on the actual speed, the feature adjusts a speed limit (i.e. reduces the set speed) based on the actual torque. This approach produces equivalent results in the steady state case, but may exhibit “looser” transient behavior.

The “smart entry” option (see above) is implemented by having a temporary “point A”, as seen in FIG. 3, located at the set speed but with a higher torque. The torque is initially taken to be the filtered actual engine torque, and from then on is lowered (never raised) when the filtered torque falls below it, until it reaches the calculated torque threshold.

Simply put, the soft cruise feature reduces the available torque at the cruise set speed, and ramps up the available torque back to the full-load torque curve only after the vehicle speed drops below the cruise set speed down to a calibrated delta. This effectively pre-filters the cruise control system's torque required and reduces the overall fuelling required to operate the vehicle.

By way of non limiting example, suppose a fully loaded truck/trailer cycles between full-load and no-load on a moderately hilly road. Without soft cruise a large amount of fuel is effectively wasted to allow the vehicle to climb the hill at (or close to) the cruise control set speed. When the vehicle crests the hill and begins to descend the opposite side, gravity accelerates the vehicle down the hill, the engine is not fuelling and in many cases the vehicle is coasted to speeds above the cruise set point potentially resulting in engine braking. In this situation there is a significant fuel economy loss. Soft cruise would allow less fuel wasted during the hill climb by delaying the available torque until the vehicle has slowed to a speed slightly less than the cruise set speed.)

The soft cruise feature is active when cruise control mode is active and soft cruise functionality is calibrated to be “on”. The soft cruise feature monitors the requested engine torque out of CPC2's cruise control governor. If it exceeds a calibrated horsepower threshold, corresponding to the expected maximum power needed to maintain the cruise set speed on level road, it applies a calibratable reduction to the cruise control torque request that is proportionate to the loss of vehicle speed. The set speed itself is not changed. Greater reductions are applied for higher torques, up to the calibrated limit of vehicle speed reduction, at which point the maximum available governor torque (at that speed) is allowed again.

To help compensate for lost speed (and therefore inertia) when ascending grades, the Soft Cruise feature may optionally be coupled with “looser” engine brake-on speed thresholds. This allows the vehicle to gain speed and retain inertia when descending grades to potentially prepare for the next grade ascension.

In one application, the Soft Cruise feature may introduce a second set of engine retarder On/Off speeds. When the second engine retarder is set, a new calculation runs continuously that determines a simple moving average of vehicle acceleration over the last N points (where N is calibratable, to yield the average acceleration according to the mathematical structure:

$$AverageAcceleration = \frac{{Accel}_{m} + {Accel}_{m - 1} + … {Accel}_{M - ( N - 1 )}}{N}$$

Wherein: m is a number and
   N is the number of data points

FIG. 4 is a graph representing the non linear torque response between points A and B of FIG. 3 when the soft cruise method of the present invention is activated. Specifically, in this example, the torque profile 108 is represented by an eleven (11) point torque multiplication curve between point A and point B in FIG. 3. The X axis 104 is the cruise set speed reduction, and the Y axis 106 is the torque reduction. The data points are increased monotonically from 0 to 1. Each axis is fixed even factors of 1 (ex 0,0.1,0.2 . . . 1.0)

As previously stated, in one embodiment of one method according to the present invention, the method includes using GPS map data coupled with road slope information to determine whether the vehicle is ascending or descending a hill or gradient. GPS data map information may determine road grade and provide actual road grade and predicted road grade information substantially instantaneously. In another embodiment of one method according to the present invention further includes new logic to determine when the vehicle is ascending and/or descending a grade, and approximates how steep the grade appears to be. This is accomplished by determining:
i. vehicle speed is>cruise set speed
ii. net load is zero (torque request is≦zero)
iii. if AvgAccel is positive, and ≧the calibrated threshold If it is determined that the grade is not steep, the method uses the existing set of on/off thresholds for engine retarder activation. If it is determined that the grade is steep, the method uses the alternate set of on/off thresholds for engine retarder activation until the retarder is completely deactivated, at which point a new grade evaluation can be done.

FIG. 5 is a software flowchart representative of one method 86 according to the present invention. Specifically, Step 88 is applying cruise control to an operating engine in a vehicle. Step 90 is operating the vehicle to maintain the vehicle speed and requested torque within requested limits. Step 92 is applying reduction to the engine torque proportional to vehicle speed loss when the cruise control torque exceed engine horsepower thresholds corresponding to a maximum horsepower required to maintain a set speed on a level surface.

The words used in this specification are words of description, and not words of limitation. Those skilled in the art recognize that many variations and modifications are possible without departing from the scope or spirit of the invention as set forth in the appended claims.

1. A method to operate a vehicle with an electronically controlled internal combustion engine equipped with an electronic control unit with memory and capable of operating the engine in a cruise control mode, comprising:
a) applying a cruise control set speed;
b) monitoring actual vehicle speed and requested cruise control engine torque to operate vehicle within predetermined limits; and
c) applying a calibratable reduction to said cruise control engine torque proportional to a loss of vehicle speed when said cruise control engine torque exceeds a calibratable horsepower threshold corresponding to a calculated maximum horsepower required to maintain said cruise control set speed on a substantially level surface.

2. The method of claim 1 further including a beyond predetermined calibratable vehicle speed reduction, at which maximum engine torque is made available at that vehicle speed.

3. The method of claim 1, further including calibratable engine brake on speed thresholds to permit said vehicle to given speed and retain inertia when said vehicle is descending a grade to partially prepare to ascend a next grade.

4. The method of claim 1, further including calibratable engine retarder on/off speeds.

5. The method of claim 4, further including determining a simple moving average of vehicle acceleration over a calibratable set of data points to determine average acceleration according to formula:
$$AverageAcceleration = \frac{{Accel}_{m} + {Accel}_{m - 1} + … {Accel}_{M - ( N - 1 )}}{N}$$
Wherein; m is a number and
N is a number of data points.

6. The method of claim 5, further including determining whether said vehicle is descending a grade and how steep is such a grade by measuring whether vehicle speed is greater than cruise set speed, net load is zero and whether average acceleration is positive and greater than or equal to a calibrated threshold.

7. The method of claim 5, wherein a Global Position Satellite (GPS) system is used to determine actual road grade and predicted road grade; said GPS system having data indicating road grade above a predetermined calibratable threshold.

8. The method of claim 1, wherein said control of vehicle speed and engine torque is non linear.

9. The method of claim 1, further including a timer to delay activation of cruise control is enabled while vehicle is operating at or above a predetermined load.

10. The method of claim 5 further including determining whether a grade is steep by comparing a simple moving average of vehicle acceleration to a predetermined programmable vehicle acceleration threshold.

11. The method of claim 5 further including determining actual horsepower is less than a calibratable maximum horsepower before applying calibratable reduction to the cruise control engine torque.

12. The method of claim 1, further including timer to delay activation when cruise control has been paused and then re-enabled.

13. The method of claim 1, further including a low pass filter on engine brake torque to determine engine torque reduction.

14. The method of claim 4, further including selecting engine retarder on/off thresholds on a per hill basis.
